(19) United States
(12) Patent Application Publication
(10) Pub. No.: US 2010/0329941 A1
(43) Pub. Date: Dec. 30, 2010

(54) OUTPUT CONTROL FOR OZONE GENERATORS

(76) Inventors: Mark Edward Moore, Versailles, KY (US); Aaron J. Cena, Mt. Shasta, CA (US)

Correspondence Address: MACCORD MASON PLLC, 300 N. GREENE STREET, SUITE 1600, P. O. BOX 2974, GREENSBORO, NC, 27402, US

(21) Appl. No.: 12/825,793

(22) Filed: Jun. 29, 2010

Related U.S. Application Data
(60) Provisional application No. 61/221,638, filed on Jun. 30, 2009.

(51) Int. Cl. B01J 19/08

(52) U.S. Cl. 422/186.15; 422/186.07

(57) ABSTRACT

Systems, devices and methods for controlling ozone output are shown and described. In one example, the disclosure is directed to an ozone output system for supplying ozone to at least one of a plurality of devices that demand ozone. The system may comprise an ozone generator arranged to provide ozone to at least one device, a pulse density modulation output, an inverter-based power delivery (IBPD) circuit, and an output control circuit (OCC).

### RELATED APPLICATIONS

This application claims priority to U.S. Patent Application No. 61/221,638 filed 30 Jun. 2009.

### FIELD OF TECHNOLOGY

The current disclosure relates generally to ozone generators, and more particularly to output control for ozone generators.

### BACKGROUND

Ozone (O₃) is known in the art. It is a molecule composed of three atoms of oxygen. Ozone generating devices are also known in the art. Such devices may create ozone by contacting oxygen (O₂) with either ultraviolet light or electricity. The ultraviolet light or electricity breaks some of the oxygen molecules, each consisting of a pair of single oxygen atoms, into numerous single oxygen atoms. These single oxygen atoms reform into ozone molecules.

Ozone generating devices may control ozone output in a variety of ways. Some devices, for example, use sensors or controllers to measure ozone output or demand and then produce an output, such as a proportional voltage or current, to meter ozone. Applicants believe that such strategies suffer from any combination of problems including, expense, requiring regular calibration, requiring maintenance, being limited to modulating ozone output for a single point of ozone use, etc.

Ozone generating devices may also control output manually. For example, devices may use a rheostat or potentiometer that is manually adjusted to cause the ozone generator to produce a certain amount of ozone, but must be manually re-adjusted if the ozone output requirements change, which would be very cumbersome in a situation where ozone demand could change repeatedly during a short period of time. Applicants believe that such strategies may be impractical for many types of applications, e.g., complicated or industrial. Further, these types of controls are labor intensive.

The current disclosure is directed to any combination of these or additional problems.

### SUMMARY

This disclosure is directed to, inter alia, devices and methods for controlling ozone output. The disclosure is also directed to, for example, systems having improved ozone control.

In one example, the disclosure is directed to an output control circuit (OCC) comprising a supply terminal, a plurality of switches, a first bank of resistors (B1), a second bank (B2), and a PDM input.

In another example, the disclosure is directed to an ozone output system for supplying ozone to at least one of a plurality of devices that demand ozone. The system may comprise an ozone generator arranged to provide ozone to at least one device, a pulse density modulation (PDM) output, an inverter-based power delivery (IBPD) circuit, and an OCC.

In another example, the disclosure is directed to a method of controlling the delivery of ozone to at least one of a plurality of devices that demand ozone. The method includes providing an OCC, interfacing the OCC with a pulse density modulation (PDM) output, and interfacing the PDM input with an ozone generator.

Using, for example, a device, a system, or a method as briefly described above, a demand of ozone by any of a plurality of devices results in a supply of ozone to the device demanding ozone in an calibrated and virtually maintenance-free approach. The disclosure also allows for additional ozone generation in response to demand by additional devices.

The above summary was intended to summarize certain embodiments of the present disclosure. Systems, methods and devices will be set forth in more detail, along with examples illustrating efficacy, in the figures and detailed description below. It will be apparent, however, that the detailed description is not intended to limit the present invention, the scope of which should be properly determined by the appended claims.

### BRIEF DESCRIPTION OF THE FIGURES

FIG. 1 illustrates one example of a system as described herein;

FIG. 2 illustrates one example of an ozone control circuit as described herein; and

FIG. 3 illustrates another example of an ozone control circuit as described herein.

### DETAILED DESCRIPTION OF THE EXEMPLARY EMBODIMENTS

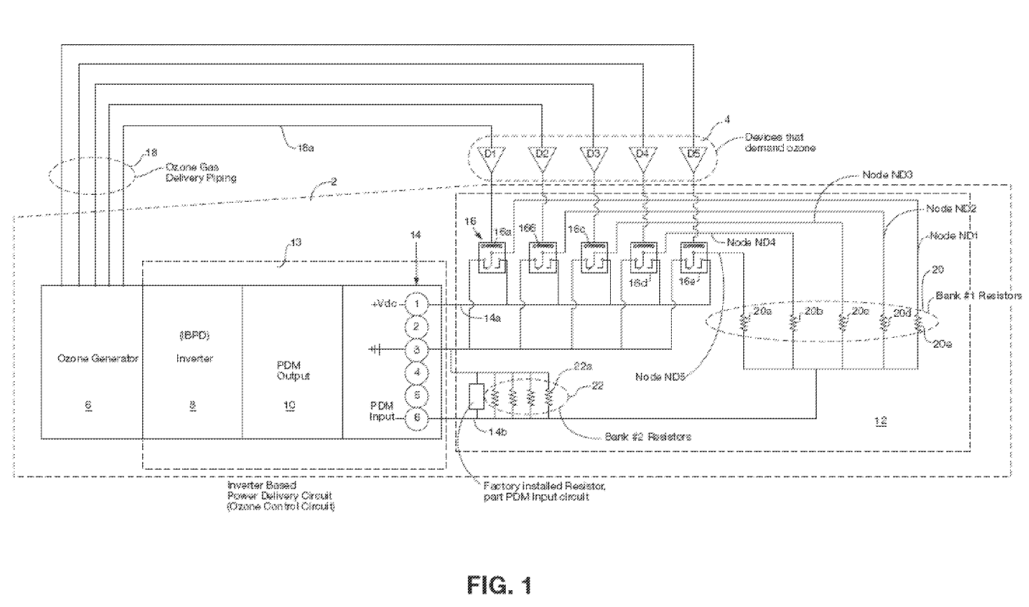

FIG. 1 illustrates one example of an ozone output system 2 for supplying ozone to at least one of a plurality of devices 4 that demand ozone. Devices 4 may represent any of a variety of devices, for example, any number of ozone washing machines, etc. In this example, devices 4 include a first device (D1), a second device (D2), a third device (D3), a fourth device (D4) and a fifth device (D5), however, pluralities of devices may include any number of devices, e.g., more or less, such as 2, 3, 4, 6, 7, 8, 9, 10, 11, etc.

In the depicted example, system 2 includes ozone generator 6, inverter-based power delivery (IBPD) circuit 8, pulse density modulation (PDM) output 10, and ozone control circuit (OCC) 12. Ozone generator 6 will also typically be interfaced with at least one of the devices 4, more typically with at least two, at least three, at least four, etc., or all of the devices, for example, using piping 18.

IBPD circuits and PMD controls used in the system may vary from example to example. Exemplary IBPD circuits will include an inverter that sends an output to a transformer, e.g. a high-voltage transformer. The transformer may be used to elevate the voltage from the inverter to allow for discharge across the ozone generation cell, thereby allowing for the generation of ozone. IBPD circuits may also be adjustable, for example, to adjust to a requisite or optimum voltage or amplitude of an ozone generator being used (e.g., an optimum output).

Exemplary PMD outputs will be in communication with the IBPD circuit and convey output to the OCC in the form of a pulse. In typical examples, the IBPD circuit is adjusted to provide an optimum output, e.g. for an ozone generator or for a particular system configuration. PMD output can then be used to adjust ozone production without significant deviation from the optimum output, e.g. pulsed output will contain the optimum amplitude and pulse-width.

In some examples, the IBPD circuit and the PDM output may be present on a single device, e.g. device 13, but in other examples, IBPD circuit and PDM output may be different devices. Similarly, ozone generators and transformers may be located on any number of devices. The SSD110, from Plasma Technics, Inc., represents a suitable example of device 13 having both an IBPD circuit and a PMD control suitable for performing in systems as disclosed herein. Other IBPD circuits and PMD outputs would be readily recognizable by those have ordinary skill in the art, given the teachings herein.

Referring back to FIG. 1, PMD output 10 is interfaced with OCC 12 through a plurality of interfaces 14, which may be considered to represent terminal interfaces between circuits or devices. OCC circuits may also include a plurality of terminals, and OCC inputs into interfaces 14 may be considered to represent OCC terminals. For example, OCC 12 includes supply terminal 14a and PDM input terminal 14b (also referred to herein as PDM input).

As seen, OCC 12 includes a plurality of switches 16, e.g., relays, including a first switch (S1)16a, a second switch (S2) 16b, a third switch (S3) 16c, a fourth switch (S4) 16d and a fifth switch (S5) 16e. Switch number may vary, for example, depending on the number of devices demanding ozone or the switch configuration desired. Switches 16 are arranged to switch on when a corresponding device demands ozone. For example, S1 is arranged to switch on when D1 demands ozone, S2 is arranged to switch on when D2 demands ozone, etc.

OCC 12 also includes a first bank (B1) 20 of resistors. In this example, B1 includes a first resistor (B1R1) 20a, a second resistor (B1R2) 20b, a third resistor (B1R3) 20c, a fourth resistor (B1R4) 20d, and a fifth resistor (B1R5) 20e. Typically, switches 16 are arranged in parallel, and resistors in B1 20 are arranged in parallel, with individual switches 16 arranged in series with corresponding resistors in B1 to form a plurality of nodes arranged in parallel. For example, S1 and B1R1 form at least part of a first node (ND1), S2 and B1R2 will form at least part of a second node (ND2), etc.

Resistors in the B1 may be any combination of fixed or variable resistors. For example, fixed resistors may be configured to allow for different or equal amounts of ozone to be produced for each device. In other examples, variable adjustable resistors or trimmer pots may be used and set at the same value as the fixed resistors or at different values. Variable configurations could then allow for, for example, field adjustment or calibration to field adjust or calibrate the individual outputs to each device turning or trimming the resistors (trimmer pots) and increasing or decreasing the setpoints of the resistors.

OCC 12 may also include a second bank (B2) 22, which is connected in series with B1, and which can be arranged to include at least one resistor (B2R1) 22a. The number and resistance of resistors in the B2 can be adjusted as needed when the system is employed, as explained further below. Further, in some examples, a factory, or pre-installed, resistor may be used, e.g. in the B2 or downstream from the B2, for example, to provide a minimum level or resistance at all times.

In terms of operation, for each device 4 that demands ozone, the system will provide an increase in the % of ozone max output that is matched to the amount of ozone that the device needs. For example, IBPD circuit 8 provides a voltage to PDM output 10, which supplies a pulse to terminal 14a. When D1 demands ozone, switch 16a is turned on, thereby activating ND1, which modulates the supplied pulse via B1R1 20a. The supplied pulse undergoes a further modulation in B2 before reaching ozone generator 6, where voltage is used to create discharge across an ozone generation cell and generate ozone. Ozone produced at generator 6 is pulled to D1, by an injector in D1 for example, through pipe 18a of ozone piping 18. Upon the demand of ozone by D2, ND2 is activated thereby decreasing resistance and increasing ozone production at ozone generator 6, similarly as described for D1. A D2 injector pulls ozone for use at D2. In this example, devices are considered to each contain an injector or pump for pulling ozone generated from ozone generator 6 to the device demanding ozone, e.g. at a predetermined rate. In other examples, ozone generators or control systems may include valves or pumps upstream from the device demanding ozone for selectively providing ozone to the device making the demand. For example, an upstream pump and valve may be under the control of the device demanding ozone. Still, in other examples, devices may demand and/or be provided ozone in other ways, e.g., pumps that pump at various rates, etc.

The efficacy of the disclosure is further illustrated in the example below, which is not for limiting the scope of the claimed invention.

### Example

A system having an OCC is designed to provide ozone for five devices that demand ozone (D1-D5) in an equal amount. The system is configured such that the number of nodes=number of devices that demand ozone, i.e. 5. The % of maximum ozone output for each node=100%/number of nodes (100%/5)=20% per node.

The switches are relay switches. The B1 resistors are 10 k-ohm resistors. The OCC has a pre-installed resistor, which is a 20 k-ohm resistor. The B2 includes 4 20 k-ohm resistors. In this example, the number of B2 resistors is determined by the number of nodes, such that the number of 20 k-ohm resistors=(Number of nodes)−1 (thereby accounting for the pre-installed 20 k-ohm resistor). In other examples, any number of B2 resistors could be used, provided, for example, that they create the same total resistance as the four parallel 20 k-ohm resistors, or some other corresponding resistance. It is also possible that the resistance value be supplied not by use of various combinations of fixed resistors, but by use of one or more variable resistors (rheostats or potentiometers or “trimmer pots”).

Ozone generator output is adjusted higher or lower depending on the number of devices demanding ozone. When no devices demand ozone, no nodes are turned on and 0% of maximum ozone is generated. When device 1 demands ozone, node 1 is turned on and 20% of maximum ozone output is generated. An injector in device 1 pulls ozone from the generator. When device 2 demands ozone, node 2 is turned on and 40% of maximum ozone output is generated. An injector in device 2 pulls ozone from the generator. When device 3 demands ozone, node 3 is turned on and 60% of maximum ozone output is generated. An injector in device 3 pulls ozone from the generator. When device 4 demands ozone, node 4 is turned on and 80% of maximum ozone output is generated. An injector in device 4 pulls ozone from the generator. When device 5 demands ozone, node 5 is turned on and 100% of maximum ozone output is generated. An injector in device 5 pulls ozone from the generator.

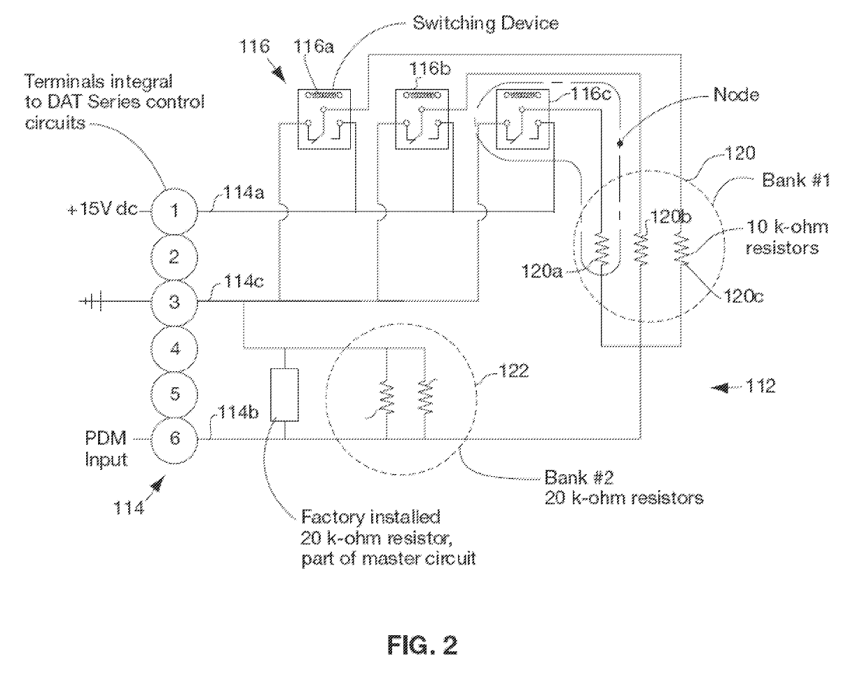

In addition to systems, the current disclosure is also directed to devices, e.g. OCC 12, for using in systems. FIG. 2 illustrates another OCC example, OCC 112, which is somewhat similar to OCC 12. OCC 112 includes a plurality of terminals 114 for interfacing with systems. As seen, OCC 112 includes supply terminal 114a and PDM input terminal 114b (also referred to herein as PDM input). OCCs may also include ground 114c.

OCC 112 includes a plurality of switches 116, including a first switch (S1) 116a, a second switch (S2) 116b, and a third switch (S3) 116c. As noted above, switch number may vary, for example, depending on the number of devices demanding ozone or the switch configuration desired. Switches 116 are arranged to switch on when a corresponding device (not shown in this figure) demands ozone. For example, S1 is arranged to switch on when D1 demands ozone, S2 is arranged to switch on when D2 demands ozone, etc.

OCC 112 also includes a first bank (B1) 120 of resistors. In this example, B1 includes a first resistor (B1R1) 120a, a second resistor (B1R2) 120b, and a third resistor (B1R3) 120c. Typically, switches 116 are arranged in parallel, and resistors in B1 120 are arranged in parallel, with individual switches 116 arranged in series with corresponding resistors in B1 to form a plurality of nodes arranged in parallel, e.g. node 1 and node 2. In the example, the resistors are 10 k-ohm resistors, but resistors in the B1 may be any combination of fixed or variable resistors.

OCC 112 may also include a second bank (B2) 122, which is connected in series with B1, and which can be arranged to include at least one resistor (B2R1) 122a. In this depiction, B2R1 122a and B2R2 122b are arranged in parallel. The number and resistance of resistors in the B2 can be adjusted as needed when the system is employed.

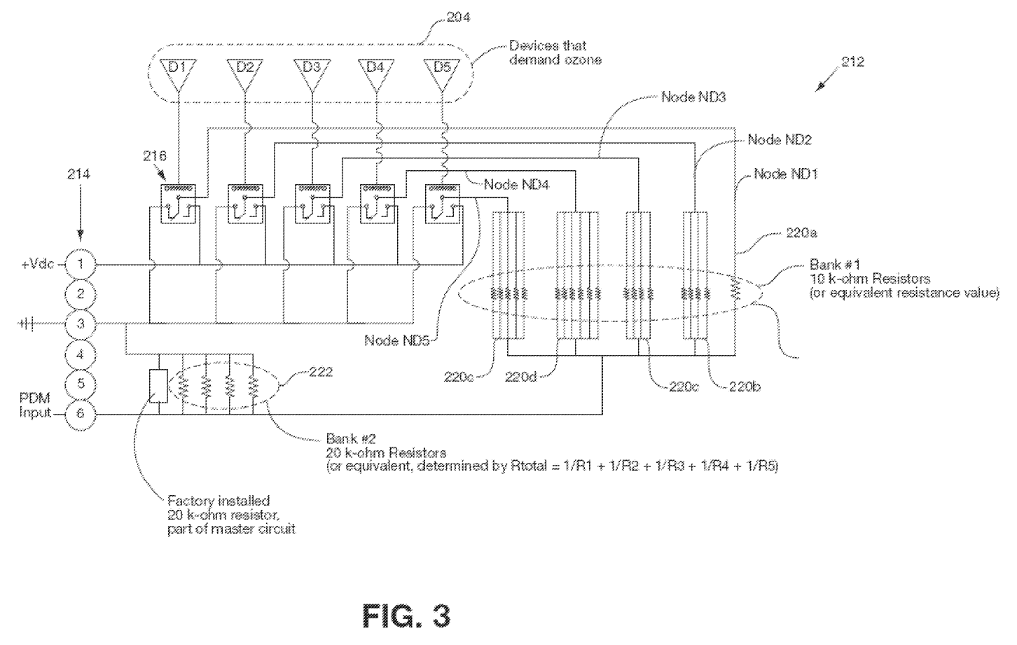

FIG. 3 illustrates another example of an OCC, whereby ozone supply is further controlled by B1 resistor arrangement. One of the benefits of the some examples of the disclosure is that OCCs can be modified to produce non-incremental increases in ozone, as illustrated in FIG. 3, thereby allowing for the supply of ozone to devices that demand different amounts of ozone. In this figure, OCC 212 is in communication with devices 204 that demand different amounts of ozone. For example, D1 may demand 5% of maximum ozone output, D2 may demand 20% of maximum ozone output, D3 may demand 20% of maximum ozone output, D4 may demand 30% of maximum ozone output, and D5 may demand 25% of maximum ozone output. By adjusting the resistance of the various nodes, different levels of ozone production may be achieved. In this example, the resistance needed in the B1 and B2 may be calculated as follows:
The smallest of % of maximum output that is required by any of the Devices is 5%, i.e., D1 and Node ND1. Therefore, the total number of 10 k-ohm resistors that will be used in Bank #1 is calculated as:
Number of 10 k-ohm resistors=100%/Smallest % of maximum output
=100%/5%
=20 resistors of 10 k-ohm are required

The number of 10 k-ohm resistors that will be attached to each other in parallel for Node's ND1-ND5, is calculated as follows:
Number of resistors for an individual Node (Node N“xx”)=% of maximum output for the individual Node/smallest % of maximum output required by a Device
Node NDI
=5% of maximum output/5%
=1 resistor of 10 k-ohm for B1R1 220a of Node ND1.
Node ND2
=20% of maximum output/5%
=4 resistors of 10k-ohm for B1R2 of Node ND2. B1R2 220b can be attached to each other in parallel, be substituted by a single resistor of equivalent resistance, or be any combination of resistors that equal an equivalent resistance.
Node ND3
=20% of maximum output/5%
=4 resistors of 10 k-ohm for B1R3 of Node ND3. B1R3 220c can be attached to each other in parallel, be substituted by a single resistor of equivalent resistance, or be any combination of resistors that equal an equivalent resistance.
Node ND4
=30% of maximum output/5%
=6 resistors of 10 k-ohm for B1R4 of Node ND4. B1R4 220d can be attached to each other in parallel, be substituted by a single resistor of equivalent resistance, or be any combination of resistors that equal an equivalent resistance.
Node ND5
=25% of maximum output/5%
=5 resistors of 10 k-ohm for B1R5 of Node ND5. B1R5 220e can be attached to each other in parallel, be substituted by a single resistor of equivalent resistance, or be any combination of resistors that equal an equivalent resistance.

Using the above, or similar configurations, devices have different ozone demand levels can be readily supplied with ozone. Similar calculations can readily be used to determine the resistance suitable to achieve other outputs in response to different demand levels. Terminals 214, switches 216, and B2 222 of FIG. 3 may be similar to corresponding parts described above.

In addition to systems and devices, the current disclosure is also directed to methods of controlling the delivery of ozone to any of a plurality of devices, e.g., D1 and D2.

In one example, a method includes providing an output control circuit (OCC). The OCC will typically have a supply terminal and a plurality of switches, e.g., a first switch (S1) and a second switch (S2), wherein S1 is arranged to switch on when D1 demands ozone and wherein S2 is arranged to switch on when a D2 demands ozone.

The OCC may include a first bank (B1) of resistors including a first resistor (B1R1) and a second resistor (B1R2), wherein S1 and B1R1 form at least part of a first node (ND1) and S2 and B1R2 form at least part of a second node (ND2). The OCC may also include a second bank (B2) including at least one resistor (B2R1), wherein B2 is connected in series with B1. The OCC may also include a PDM input. OCC parts may be any of those shown or described above.

In this example, the method also includes interfacing the OCC supply terminal with a pulse density modulation (PDM) output and interfacing the PDM input with, for example, a corresponding interface that will control the output of an ozone generator. The supply terminal, nodes and PDM input are arranged such that demand by D1 will result in an increase in the % ozone output, thereby delivering ozone to D1, and demand by D2 will result in a further increase in the % ozone output, thereby delivering ozone to said D2. The method may further include selecting B1 and/or B2 resistance based on the number of devices needed and the amount of ozone demanded by each device.

Using the teachings contained herein, PDM input signals can be quickly and easily varied and to accurately change the output of ozone generators.

Numerous characteristics and advantages have been set forth in the foregoing description, together with details of structure and function. The disclosure, however, is illustrative only, and changes may be made in detail, especially in matters of shape, size, and arrangement of parts, and in the value of the resistors or aggregate combined resistance in ohms, within the principle of the invention, to the full extent indicated by the broad general meaning of the terms in which the general claims are expressed. Further, the various examples are not intended to be mutually exclusive. As such, parts may be considered interchangeable, for example, unless such an interchange would render the example non-functional.

Notwithstanding that the numerical ranges and parameters setting forth the broad scope of the invention are approximations, the numerical values set forth in the specific examples are reported as precisely as possible. Any numerical value, however, may contain certain errors necessarily resulting from the standard deviation found in their respective testing measurements. Moreover, all ranges disclosed herein are to be understood to encompass any and all subranges subsumed therein, and every number between the end points.

It is further noted that, as used in this specification, the singular forms “a,” “an,” and “the” include plural referents unless expressly and unequivocally limited to one referent.

What is claimed is:

1. An output control circuit (OCC) for interfacing with an ozone generator and a pulse density modulation (PDM) output and controlling ozone delivery to at least one of a plurality of devices that demand ozone, including a first device (D1) and a second device (D2), said OCC comprising:
a supply terminal configured to interface with said PDM output;
a plurality of switches including a first switch (S1) and a second switch (S2), wherein said S1 is arranged to switch on when said D1 demands ozone and wherein said S2 is arranged to switch on when said D2 demands ozone;
a first bank (B1) of resistors including a first resistor (B1R1) and a second resistor (B1R2), wherein said S1 and said B1R1 form at least part of a first node (ND1) and said S2 and said B1R2 form at least part of a second node (ND2);
a second bank (B2) including at least one resistor (B2R1), wherein said B2 is connected in series with said B1; and
a PDM input configured to provide input to said ozone generator.

2. The OCC of claim 1, further including an inverter-based power delivery (IBPD) circuit arranged to send a voltage to said PDM output.

3. The OCC of claim 2, wherein said IBPD is arranged to send a voltage sufficient to allow an ozone generator to generate ozone.

5. The OCC of claim 2, including a transformer arranged with said IBPD to increase said voltage sent to said PDM output.

6. The OCC of claim 1, wherein said plurality of switches are connected in parallel.

7. The OCC of claim 1, wherein said B1 resistors are connected in parallel.

8. The OCC of claim 1, wherein said B1 resistors include fixed resistors.

9. The OCC of claim 1, wherein the B1 resistors include variable resistors.

10. The OCC of claim 1, wherein said supply terminal, said nodes and said PDM input are arranged such that demand by said D1 will result in an increase in the % ozone output and demand by said D2 will result in a further increase in the % ozone output.

11. The OCC of claim 10, wherein said B1 resistors of said nodes are arranged such that the increase in the % ozone output in response to demand by said D2 is incremental with the % ozone output in response to demand by said D1.

12. The OCC of claim 10, wherein said B1 resistors of said nodes are arranged such that the increase in the % ozone output in response to demand by said D2 is non-incremental with the % ozone output in response to demand by said D1.

13. The OCC of claim 1, wherein said B2 is arranged such that the % ozone output is about 0% when none of said D1 or said D2 are demanding ozone.

14. The OCC of claim 1, wherein said plurality of devices that demand ozone further include a D3 and a D4, wherein said plurality of switches further include a S3 and a S4, wherein said first bank (B1) of resistors further include a third resistor (B1R3) and a fourth resistor (B1R32), wherein said S3 and said B1R3 form at least part of a third node (ND1) and said S4 and said B1R4 form at least part of a fourth node (ND2), and
wherein said supply terminal, said nodes and said PDM input are arranged such that demand by said D1 will result in an increase in the % ozone output, demand by said D2 will result in a further increase in the % ozone output, demand by said D3 will result in a further increase in the % ozone output, and demand by said D4 will result in a further increase in the % ozone output.

15. An output control circuit (OCC) for interfacing with
an ozone generator and
a pulse density modulation (PDM) output including an inverter-based power delivery (IBPD) circuit arranged to send a voltage to said PDM output, wherein said OCC is for controlling ozone delivery to at least one of a plurality of devices that demand ozone, including a first device (D1) that demands an amount of ozone, a second device (D2) that demands ozone, and a third device (D3) that demands ozone, said OCC comprising:
a supply terminal configured to interface with said PDM output;
a plurality of switches connected in parallel, including a first switch (S1), a second switch (S2), and a third switch (S3), wherein said S1 is arranged to switch on when said D1 demands ozone, said S2 is arranged to switch on when said D2 demands ozone, and said S3 is arranged to switch on when said D3 demands ozone;
a first bank (B1) of resistors connected in parallel, including a first resistor (B1R1), a second resistor (B1R2), and a third resistor (B1R3), wherein said S1 and said B1R1 form at least part of a first node (ND1), said S2 and said B1R2 form at least part of a second node (ND2), and said S3 and said B1R3 form at least part of a third node (ND3);
a second bank (B2) including at least one resistor (B2R1), wherein said B2 is connected in series with said B1; and
a PDM input configured to provide input to said ozone generator,
wherein said supply terminal, said nodes, said B2 and said PDM input are arranged such that demand by said D1 will result in an increase in the % ozone output, demand by said D2 will result in a further increase in the % ozone output, demand by said D3 will result in a further increase in the % ozone output, and the % ozone output is about 0% when none of said D1, said D2 or said D3 are demanding ozone.

16. An ozone output system for supplying ozone to at least one of a plurality of devices that demand ozone, including a first device (D1) and a second device (D2), said system comprising:
an ozone generator arranged to provide ozone to at least one of said D1 and D2;
a pulse density modulation (PDM) output;
an inverter-based power delivery (IBPD) circuit arranged to send a voltage to said PDM output; and
an ozone control circuit (OCC) including
a supply terminal interfaced with said PDM output,
a plurality of switches including a first switch (S1) and a second switch (S2), wherein said S1 is arranged to switch on when said D1 demands ozone and wherein said S2 is arranged to switch on when said D2 demands ozone,
a first bank (B1) of resistors including a first resistor (B1R1) and a second resistor (B1R2), wherein said S1 and said B1R1 form at least part of a first node (ND1) and said S2 and said B1R2 form at least part of a second node (ND2),
a second bank (B2) including at least one resistor (B2R1), wherein said B2 is connected in series with said B1, and
a pulse density modulation (PDM) input arranged to provide an output to said ozone generator.

17. The system of claim 16, including a transformer arranged to provide voltage to said PDM output.

18. The system of claim 16, wherein said plurality of switches are connected in parallel.

19. The system of claim 16, wherein said B1 resistors are connected in parallel.

20. The system of claim 16, wherein said B1 resistors include at least one type of resistor chosen from a fixed resistor and a variable resistor.

21. The system of claim 16, wherein said supply terminal, said nodes and said PDM input are arranged such that demand by said D1 will result in an increase in the % ozone output by said ozone generator and demand by said D2 will result in a further increase in the % ozone output by said ozone generator.

22. The system of claim 21, wherein said B1 resistors of said nodes are arranged such that the increase in the % ozone output in response to demand by said D2 is incremental with the % ozone output in response to demand by said D1.

23. The system of claim 21, wherein said B1 resistors of said nodes are arranged such that the increase in the % ozone output in response to demand by said D2 is non-incremental with the % ozone output in response to demand by said D1.

24. The system of claim 16, wherein said B2 is arranged such that the % ozone output is about 0% when none of said D1 or said D2 are demanding ozone.

25. The system of claim 16, wherein said plurality of devices that demand ozone further include a D3 and a D4, wherein said plurality of switches further include a S3 and a S4, wherein said first bank (B1) of resistors further include a third resistor (B1R3) and a fourth resistor (B1R32), wherein said S3 and said B1R3 form at least part of a third node (ND1) and said S4 and said B1R4 form at least part of a fourth node (ND2), and
wherein said supply terminal, said nodes and said PDM output are arranged such that demand by said D1 will result in an increase in the % ozone output, demand by said D2 will result in a further increase in the % ozone output, demand by said D3 will result in a further increase in the % ozone output, and demand by said D4 will result in a further increase in the % ozone output.

26. A method of controlling the delivery of ozone to at least one of a plurality of devices that demand ozone, including a first device (D1) and a second device (D2), said method comprising:
providing an output control circuit (OCC) having
a supply terminal,
a plurality of switches including a first switch (S1) and a second switch (S2), wherein said S1 is arranged to switch on when said D1 demands ozone and wherein said S2 is arranged to switch on when said D2 demands ozone,
a first bank (B1) of resistors including a first resistor (B1R1) and a second resistor (B1R2), wherein said S1 and said B1R1 form at least part of a first node (ND1) and said S2 and said B1R2 form at least part of a second node (ND2),
a second bank (B2) including at least one resistor (B2R1), wherein said B2 is connected in series with said B1, and
a PDM input;
interfacing said OCC supply terminal with a pulse density modulation (PDM) output; and
interfacing said PDM input with an ozone generator, wherein said supply terminal, said nodes and said PDM input are arranged such that demand by said D1 will result in an increase in the % ozone output, thereby delivering ozone to said D1, and demand by said D2 will result in a further increase in the % ozone output, thereby delivering ozone to said D2.
